(19) United States
(12) Patent Application Publication
(10) Pub. No.: US 2024/0341290 A1
(43) Pub. Date: Oct. 17, 2024

(54) MOBILE SHELLFISH TANK SYSTEM WITH WATER SHOWER

(71) Applicant: Joseph A. Zucchero, Cape Elizabeth, ME (US)

(72) Inventor: Joseph A. Zucchero, Cape Elizabeth, ME (US)

(21) Appl. No.: 18/133,989

(22) Filed: Apr. 12, 2023

(51) Int. Cl. A01K 63/02; A01K 63/00; A01K 63/04; A01K 63/06

(52) U.S. Cl. CPC A01K 63/02; A01K 63/006; A01K 63/045; A01K 63/065

(57) ABSTRACT

A mobile shellfish retention tank system with a water shower system that are together positioned on a movable cabinet. The water shower system is arranged to disperse a minimal volume of chilled water into the tank to keep alive any shellfish located therein. The tank may include porous trays for holding the shellfish that are showered with the chilled water. Multiple species of shellfish are easily moved into the tank and removed from the tank. Minimal maintenance is required as very little water is used.

### BACKGROUND OF THE INVENTION

### 1. Field of the Invention

The present invention relates to shellfish tanks. More particularly, the present invention relates to shellfish tanks arranged to employ minimal water to keep shellfish wet for an extended period of time. Further, the present invention is related to a shellfish tank system that is mobile.

### 2. Description of the Prior Art

Shellfish including lobsters, oysters, clams, mussels, and crabs, as well as other shelled marine life, are a desirous food source. Shellfish are often sold live to consumers, whether retail such as through supermarkets, or wholesale, such as through restaurants. Shellfish are also put on display, such as at aquariums and other educational settings, where it is of value to keep them alive while on display. That may include keeping them on ice but not limited thereto.

Therefore, there are many instances in which shellfish are kept alive in a displayed fashion so that they can be easily observed by consumers and others. However, shellfish are very sensitive to their environment and so it is necessary to keep them in an environment configured to keep them alive and fresh as long as possible. In order to do so, the environment must be wet, relatively cold, and with a salinity close to that of seawater.

Existing systems for keeping shellfish alive for extended periods of time while on display tend to include a tank with transparent walls, a water supply, and circulation, filtration, and water cooling mechanisms. The tank is substantially filled with the water, which must be maintained at a suitable salinity level, and the circulation, filtration, and cooling mechanisms must be powered constantly to keep the shellfish alive. In any commercial setting, the tank must be of a substantially size to hold dozens of shellfish in a consumption setting such as a supermarket or a restaurant. It is a common sight in a supermarket to see a large tank with circulating water and lobsters crawling all over each other. Keeping all of them alive until selected by consumers is important to the retailer.

It is also noteworthy that in most existing shellfish retention tanks, there is only one species per tank. This may be due to state regulation prohibiting the mixing of species in one tank. As a result, a minimum of two such tanks is needed to retain two different species, such as lobsters and crabs. There may even be a need to have multiple tanks to keep shellfish of the same species, but different sizes separated so that larger ones do not consume smaller ones. Otherwise, the process for switching from one species to another is a time consuming activity.

The need for large retention tanks that can hold large quantities of shellfish coupled with the obligation to keep these tanks substantially full of continuously treated water makes for massive structures that are hard to move about, take up substantial room, and require constant attention. It also requires substantial volumes of water. A compact-sized tank would be preferred. What is needed is a better way to maintain shellfish and even other aquatic animals in a living state for an extended period of time. More specifically, what is needed is a retention tank that can hold different species of shellfish and/or different sizes of the same species in order to reduce the number of tanks required to hold different species. What is also needed is a retention tank that requires the use of substantially less water to keep the shellfish alive in order to reduce maintenance cost and tank size. Further, what is needed is such a retention tank that is mobile in order to be easily transported around a facility with limited set up requirement.

### SUMMARY OF THE INVENTION

It is an object of the present invention to provide a hygienic and mobile shellfish retention tank system. It is also an object of the invention to provide a retention tank system that can hold different species of shellfish and/or different sizes of the same species. Further, it is an object of the invention to provide a mobile shellfish retention tank system that requires the use of substantially less water to keep the shellfish alive in order to reduce maintenance cost and tank size.

These and other objects are achieved with the present invention, which is a mobile shellfish retention tank system. The mobile tank system of the invention includes a plurality of trays spaced vertically from one another in a retention tank of the system wherein one species may be on one tray level while another species or shellfish of the same species but a different size may be located on another tray level. Each tray is porous to allow water to flow through to any underlying trays. The mobile tank system of the invention also includes a water distribution system in the form of a shower system. The shower system is arranged to deliver to the shellfish on the tray or trays just enough moisture to keep them wet. This eliminates the need to substantially fill the tank with water. That makes the retention tank lighter and therefore easier to move about a facility.

The trays of the mobile tank system of the present invention are modular. As a result, trays can easily be switched out in order to replace one shellfish species with another. The water shower system reduces the amount of water required to maintain the shellfish to as low as one-tenth used in a typical shellfish retaining tank. The water shower system provides a showering of very cold, filtered water sterilized by an ultraviolet system that keeps shellfish cleaner and healthier than existing systems, as well as being more cost efficient to operate.

In an example, embodiment, the retention tank of the system, while having dimensions of about 40-inches long by 25-inches wide by 42-inches high, only uses about ten gallons of water. The example tank uses a 110-V. 20-A circuit for power. It as a ½-inch thick American Cast Acrylic top. The example tank has a high-density black base and a ⅓-horsepower chiller. The tank includes a 15-watt ultraviolet sterilizer and an acrylic sump. It also includes a full filter tray, a heavy-duty pump and mobile casters as described herein. It is light weight, easy to move, and easy to maintain.

More generally, the modular configuration and minimal water consumption substantially limit and make easier the maintenance required, as well as render the tank energy efficient. The components are made with tough resilient materials selected to minimize fouling and so last longer than existing tanks. The result is that a shellfish holding tank is provided that is less expensive, more mobile, and with minimal maintenance requirements as compared to existing tanks, with the added feature of a quick and easy species swap out. It provides improved hygienics with a superior fresh presentation of shellfish for the sellers and consumers of the shellfish. It costs much less than existing systems. These and other advantages will become more apparent upon review of the following detailed description, accompanying drawings and appended claims.

### BRIEF DESCRIPTION OF THE DRAWINGS

FIG. 1 is a perspective view of the mobile shellfish retention tank system of the present invention with two trays, a base tray, and a supplemental tray on top of the base tray, and the cover closed.

FIG. 2 is a top view of the retention tank system of the present invention with a single tray and no cover.

FIG. 3 is a top view of the retention tank of FIG. 2 with the cover partially open.

FIG. 4 is a top view of the retention tank of the mobile shellfish retention tank system of the present invention with the cover off, no trays, and a portion of the interior of the cabinet under the retention tank shown.

FIG. 5 is a side view of the retention tank showing the shower system and no trays.

FIG. 6 is a perspective side view of a shower tube of the present invention.

FIG. 7 is a top view of the cabinet of the mobile shellfish retention tank system of the present invention.

### DETAILED DESCRIPTION OF THE INVENTION

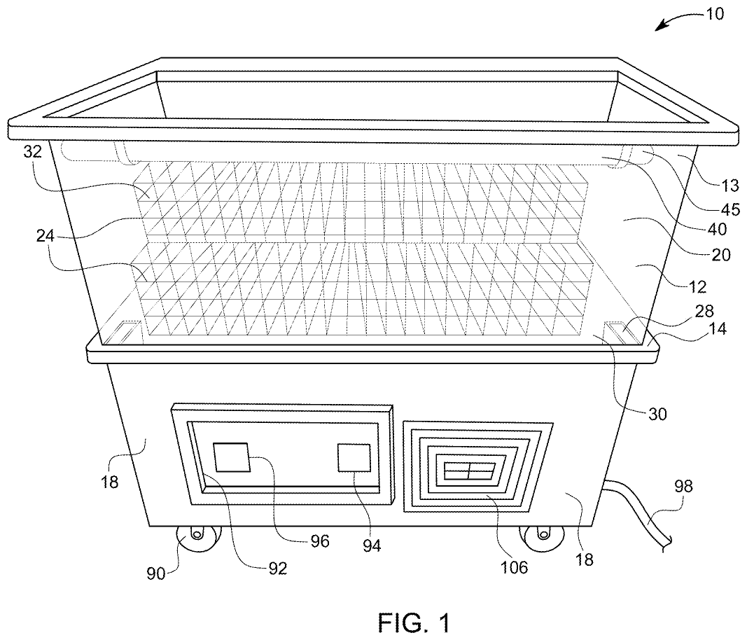

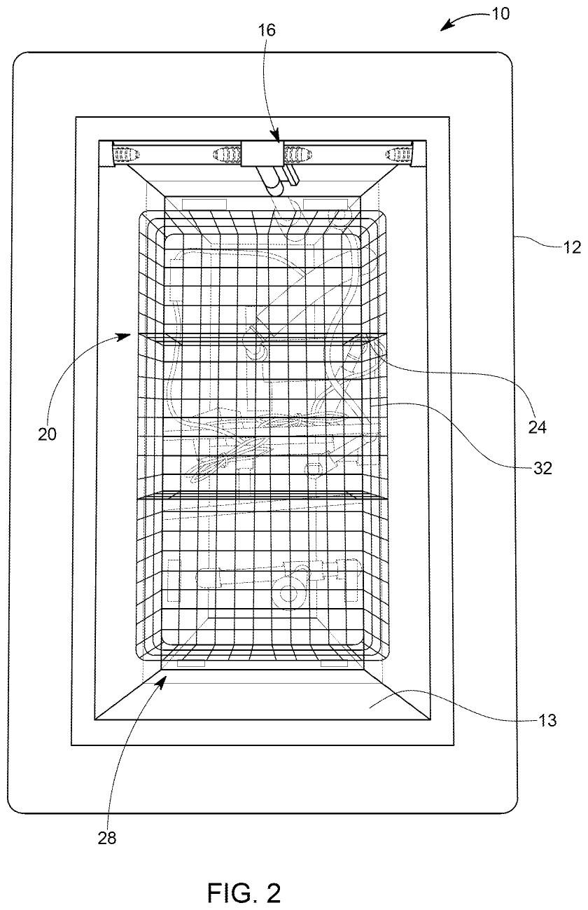

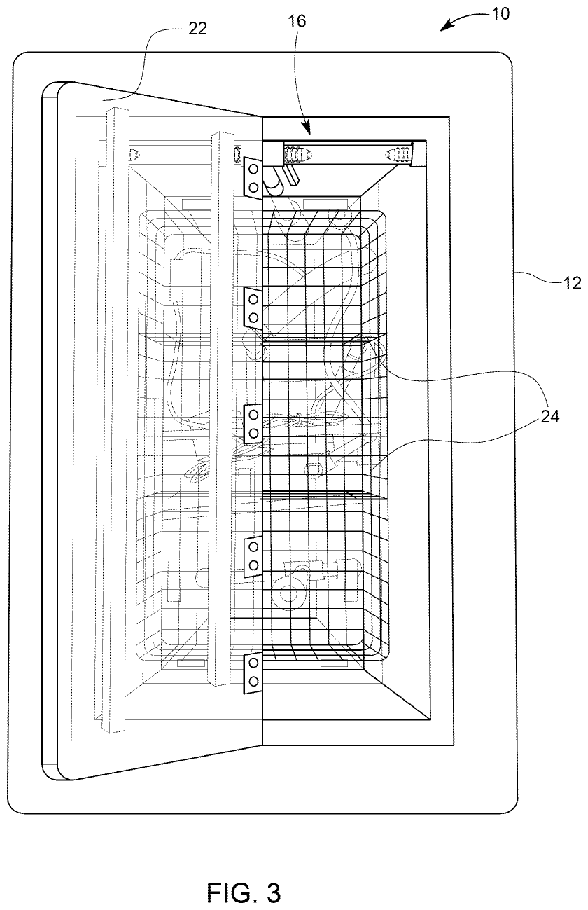

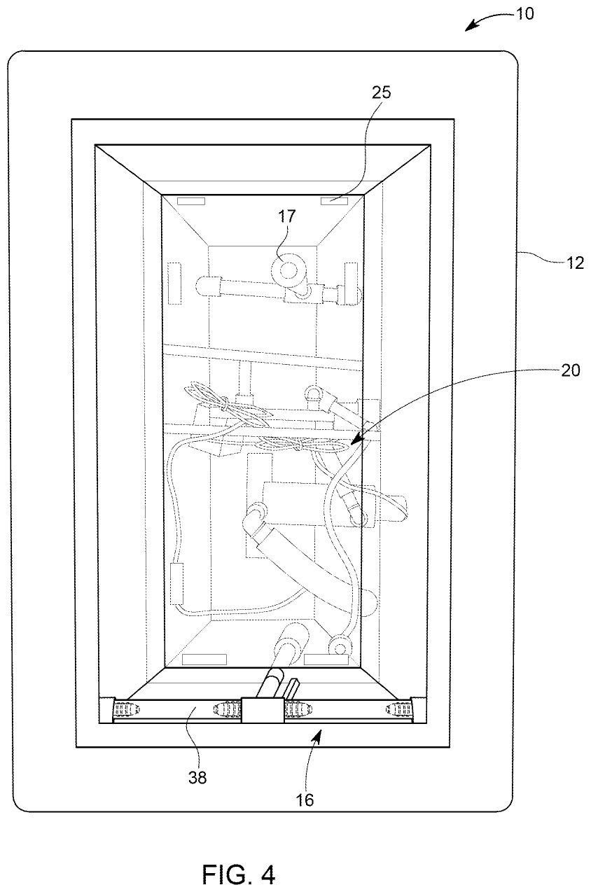

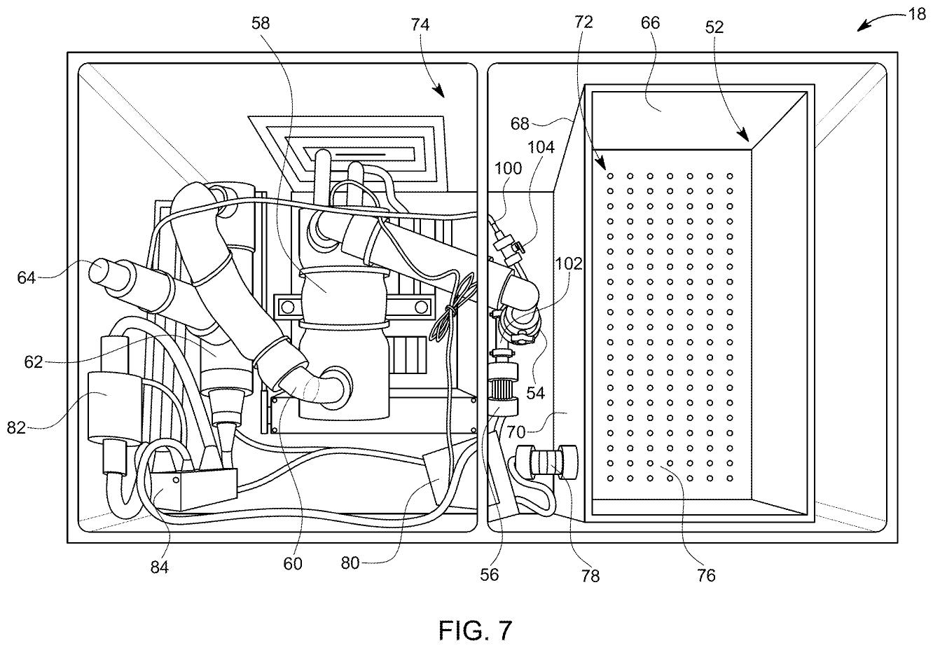

A mobile shellfish retention tank system 10 of the present invention is shown in FIGS. 1-7. The tank system 10 includes a retention tank 12 having a plurality of transparent side walls 13, a base 14, a water shower system 16, and a cabinet 18. The side walls 13 in combination with the base 14 establish a retention space 20 for retaining shellfish in the retention tank 12. The tank 12 may include an optional cover 22 that may be partially or completely detached from one or more of the plurality of side walls 13 for accessing the retention space 20. FIG. 1 shows the cover 22 closed, FIG. 2 shows no cover, and FIG. 3 shows the cover 22 partially open. The side walls 13 may be made of a nonmetallic material such as glass or plexiglass. The base 14 may be made of a nonmetallic material such as a plastic. The tank 12 includes a drain port 17 for removal of water from the retention space 20 to a sump 52 of the cabinet 18.

The retention tank 12 is arranged to enable stacking of one or more porous retaining trays 24 in the retention space 20. The one or more porous trays 24 are removably stackable on a bottom surface 26 of the base 14. The base 14 may include tank cleats 25 for insertion of at least a bottom tray to minimize sliding of the trays 24 while moving the shellfish retention tank system 10. The tank cleats 25 may alternatively be used to secure the retention tank 12 to the cabinet 18 to prevent it from sliding thereon. The one or more porous trays 24 may alternatively be removably affixed to extensions 28 extending from an interior surface 30 of two or more of the side walls 13. The trays 24 may be made of a nonmetallic material such as plastic. They may also be made of a metallic material such as Aluminum. Other materials are possible. Pores 32 of the porous trays 24 are sized sufficiently to enable water to flow through them but not so large as to allow shellfish to pass therethrough. The pores 32 may have a diameter of about one inch or be about one-inch on square but not limited thereto.

The porous trays 24 may be standalone for easy removal of individual ones. They may be sized slightly less than the length and width of the base 14. In an alternative embodiment of the trays 24, the trays 24 may include perimeter side members sized to stack additional trays 24 thereon as shown in FIGS. 2 and 3 and arranged so that water may pass through the pores 32 thereof to reach shellfish on an underlying tray or trays. The trays 24 may also be sized to be stacked adjacent to one another within the retention space 20. Regardless of the specific sizing and configuration of the porous trays 24, they are all arranged to enable retention of shellfish thereon while water is showered on them. The trays 24 may be selected to allow multiple species of shellfish and/or multiple sizes of shellfish to be retained in the retention space 20 at the same time. However, in those locations where multiple species are not allowed to exist in the tank 10 at the same time, the porous trays 24 allow the user to quickly and easily move shellfish located thereon into and out of the tank 10. In addition, the invention optionally includes one or more supplemental porous panels placeable on the one or more trays 24. These panels may have pores smaller than the pores of the trays 24. They can allow for the retention of relatively smaller shellfish species, such as oysters but not limited thereto, while being porous enough to allow the showered water to pass therethrough.

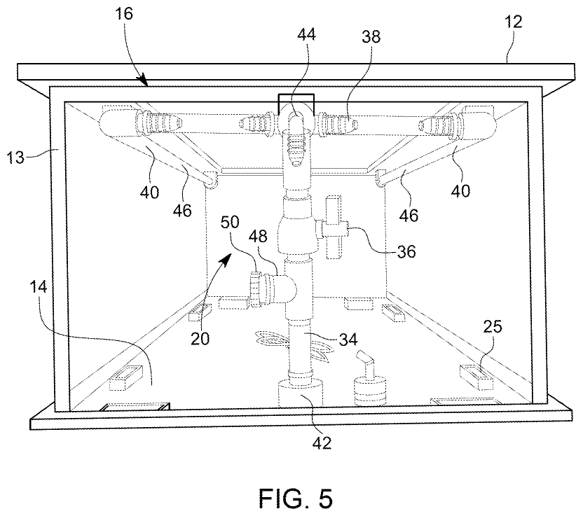

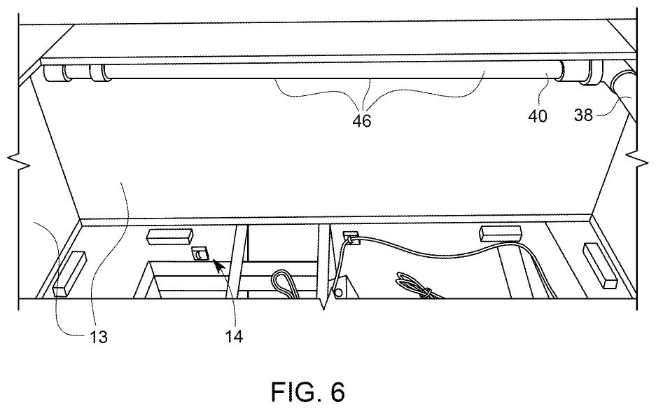

The water shower system 16 shown in FIGS. 5 and 6 includes a water supply pipe 34, a water supply valve 36, a water supply manifold 38, and one or more water shower tubes 40. The water supply pipe 34 includes an inlet 42 for receiving water from a supply in the cabinet 18 and an outlet 44 to the manifold 38. The manifold 38 delivers water to the shower tubes 40. Each of the shower tubes 40 includes an end cap 45 and a plurality of ports or nozzles 46 through which the water passes in the form of a shower into the retention space 20 of the retention tank 12. The water supply valve 36 may be used to shut off the water supply to the manifold 38. The water shower system 16 may also include a flush port 48 with a hose connect 50 that may be used to flush the shower system 16. Water is dispersed through the ports or nozzles 46 onto the contents of the retention space 20 and then exits the retention space through the drain port 17.

The cabinet 18 below the retention tank 12 includes the sump 52, a pump 54, a filter 56, a water chiller 58, a water supply conduit 60, an ultraviolet sterilizer 62, and a water transfer pipe 64 that is coupled to the inlet 42 of the water supply pipe 34 in the retention tank 12. The sump 52 is a basin established in a port of the cabinet 18. The sump 52 includes walls 66 that may be insulated with insulation 68. Wall 70 of the sump 52 functions as a bulkhead dividing a water retaining portion 72 of the cabinet 18 from a water preparation and transfer portion 74. The sump 52 may include a filter tray 76 to filter water entering from the drain port 17 of the retention tank 12. The drain port 17 may be coupled to a sump inlet tube. Water drains by gravity from the retention tank 14 through the drain 17 either directly to the filter tray 76 or through tubes that disperse the drain water entering the sump 52. A carbon filter may be placed on the filter tray 76 to enhance water filtration prior to return to the sprayer system 16. The sump 52 is arranged to contain water that is salinated. The source of the water in the sump 52 may be fresh water into which salt is added, it may be seawater, or a combination of the two.

The transfer portion 74 of the cabinet 18 includes the pump 54, the filter 56, the water chiller 58, the water supply conduit 60, the ultraviolet sterilizer 62, and the water transfer pipe 64. The pump 54 is coupled via port 78 through the wall 70 to the water in the sump 52. Water in the sump 52 is pumped by the pump 54 through the chiller 58, the water supply conduit 60 and sterilizer 62 into the water transfer pipe 64. The water is first passed through the filter 56 and the water chiller 58 before entering the shower system 16. The temperature of the water is regulated with the chiller 58 that is controlled by temperature controller 80. The temperature of the water supplied to the shower system 16 may be about 39 deg. F. but not limited thereto. The transfer portion 74 also includes a sterilizer ballast 82 for regulating the ultraviolet sterilizer 62, and a power supply 84 for powering components of the system 10 located in the cabinet 18.

The nozzles 46 of the shower tubes 40 are arranged to have an outlet configured to produce a showering of the filtered and chilled water. The nozzles 46 are designed to spray the water into the retention space 20. The nozzles configuration and the size, number, and spacing of the shower tubes 40 are selected to ensure that substantially all of the retention space 20 is covered with dispersed water when the pump 54 is activated. As a result, the shellfish in the retention space 20 will be contacted by the chilled water. As one example, for a version of the tank 12 that is 36″ long by 24″ wide by 24″ in height, with shower tubes 40 that are about one-inch diameter extending about 18 inches long and nozzles that are about ⅛-inch in diameter, two shower tubes 40 positioned on opposing walls 13 of the tank 12 in an upper portion thereof is sufficient to provide complete coverage of shellfish in the retention space 20 with chilled water that will keep them alive and healthy for a period of days. The number of tubes 40 and the nozzle sizes are not limited thereto.

The cabinet 18 is sized to hold the tank 12 thereon. It can include rollers 90 for complete mobility of the tank system 10 to a location of interest whether the retention space 20 is filled or empty. The cabinet 18 may include a cabinet door 92. The cabinet 18 may also include a controller 94 that is coupled to the pump 54 for regulating operation of that device. The controller 94 may also include a display 96 for the user to observe information about performance of the tank system 10, such as temperature of the retention space 20, water flow rates, contaminant levels in the retention space 20, and any other information of interest.

The cabinet 18 also includes a drain outlet 98 to add or remove water to or from the sump 52. The transfer portion 74 may also optionally include a sweeper tube 100 coupled to manifold 102 that may be actuated with sweeper valve 104 coupled to the pump 54. The sweeper tube 100 may be employed as a separate feeder line to a nozzle positioned to an upper side of the base 14 to move water on that upper side and aid in filtering the water by minimizing material buildup on the base 14. The cabinet 18 may include a vent 106 to enable cooling of the apparatuses in the transfer portion 74 of the cabinet 18. Intake and exhaust fans may be included therein.

The tank system 10 of the present invention enables a user to easily move it to any location of interest. The use of a limited amount of water with the water shower system 16 minimizes tank weight, reduces water usage, limits maintenance requirements. The water shower system 16 is arranged to keep shellfish cold and wet enough to stay alive for an extended period of time. In an example of the invention, all but one lobster in a group of 25 pounds of lobsters were kept alive for five days using only 10 gallons of water.

The present invention has been described with reference to specific examples and configurations. It is only intended to be limited to the description set out in the claims and equivalents.

What is claimed is:

1. A mobile shellfish retention tank system comprising:
a plurality of transparent sidewalls that are coupled together and establish a retention tank with a shellfish retention space therein;
a base joined to the plurality of transparent sidewalls that establishes a substrate of the retention space;
a water shower system extending at least partially into the retention space above the base; and
a cabinet for removably supporting the retention tank thereon, wherein the cabinet is wheeled to enable movement of the retention tank, and
wherein the water shower system is arranged to disperse a minimal volume of water into the retention space to keep alive any shellfish located therein.

2. The mobile shellfish retention tank of claim 1 further comprising one or more porous trays located in the shellfish retention space.

3. The mobile shellfish retention tank of claim 1 wherein the water shower system includes a plurality of shower tubes coupled to a water supply.

4. The mobile shellfish retention tank of claim 3 wherein the water supply is a sump located in the cabinet.

5. The mobile shellfish retention tank of claim 3 wherein each of the plurality of shower tubes includes a plurality of nozzles arranged to shower water into the retention space.

6. The mobile shellfish retention tank of claim 1 further comprising a filter, a water chiller, and a sterilizer in the cabinet, wherein water dispersed by the water shower system first passes through the filter, the water chiller, and the sterilizer.

7. The mobile shellfish retention tank of claim 6 wherein the water chiller chills the water going to the water shower system to a temperature of about 39 deg. F.

8. The mobile shellfish retention tank of claim 2 wherein there are two porous trays, wherein one of the two porous trays is stacked on top of the other of the two porous trays.

9. The mobile shellfish retention tank of claim 8 wherein the one of the porous trays is arranged to hold a first species of shellfish and the other of the porous trays is arranged to hold a second species of shellfish.

10. The mobile shellfish retention tank of claim 1 further comprising a removable lid.

11. The mobile shellfish retention tank of claim 2 further comprising one or more porous panels removably placeable on the one or more porous trays.
